(19) United States
(12) Patent Application Publication
(10) Pub. No.: US 2006/0068912 A1
(43) Pub. Date: Mar. 30, 2006

(54) Method of conducting a network virtual software game

(75) Inventor: Win-Harn Liu, Taipei (TW)

Correspondence Address: Welsh & Katz, Ltd.;Eric D. Cohen, 22nd Floor, 120 South Riverside Plaza, Chicago, IL, 60606, US

(73) Assignee: Inventec Corporation, Taipei (TW)

(21) Appl. No.: 10/953,748

(22) Filed: Sep. 29, 2004

(51) Int. Cl. G06F 17/00; G06F 19/00

(52) U.S. Cl. 463/42

(57) ABSTRACT

Disclosed provides a method of conducting a network virtual software game. First, a network terminal collects user's data and transfers the user's data to a server. The server verifies the user's data. The server then looks up and displays the parameter data of the online software game machine. The network terminal receives and transfers the software game parameter data set by the user to the server. According to the software game parameter data set by the user, the server then conducts a game computation process. The network terminal receives and displays in real-time the game computation process and its results thereof. Lastly, according to the results of the game computation process, the server allocates the user's data. Remote playing of the virtual software game can be thereby achieved.

### BACKGROUND OF THE INVENTION

1. Field of Invention

The present invention relates to a method of conducting a network virtual software game, and more particularly to a method implementing network communication for playing a software game.

2. Related Art

Software games have been developed for many years and nowadays have become a significant industry. Traditionally, a software game machine has to be embodied in a physical apparatus occupying a physical location, so that the player cannot remotely manipulate the software game machine. Further, one single software game machine can be manipulated by only one player, and the number of players can be increased only by increasing the number of software game machines.

As the technology advances, less and less labors are needed for most works, and longer leisure time becomes available. As the living standard increases, people also have more money to afford entertainment of higher requirements. In the example of game entertainment, if people have to go to a specific location to set an actual game stake, substantial time may be wasted and the individual person may be even discouraged to participate to the game if the game location is crowded. The game attraction therefore may be impaired.

Nowadays, the progress of Internet technology has rendered remote manipulations possible and an increasing number of tasks no longer need the physical presence of persons for performance. Furthermore, as portable appliances are provided with wireless communication functionality, the user can access network at any remote location, to perform transactions and manipulations. The use of a communication network, to access and manipulate software game, therefore has become a hot spot for many industrials.

### SUMMARY OF THE INVENTION

It is therefore an objective of the invention to provide a method of conducting a network virtual software game that uses network connection for people to remotely manipulate virtual software games.

According to the invention, the method uses network connection to access online to a virtual software game machine to put a game stake. First, a network terminal collects the user's data and transfers the data to a server. The server verifies the user's data. The server then looks up and displays parameter data of the online software game machine. The network terminal receives a software game parameter data set by the user and transfers it to the server. According to the software game parameter data set by the user, the server then conducts a game computation process. Then the network terminal receives and displays the game computation process and the results in real time. Lastly, the server allocates the user's data according to the results of the game computation process.

In the invention, a connection is established between a network terminal and a server, to conduct the transfers of user's data and software game data, which thereby achieves remote playing of the virtual software game. The user thereby can play video games at any location via a communication terminal.

Further scope of applicability of the present invention will be presented from a detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention can be fully understood from the detailed description given in the illustration below itself, which doesn't limit the implementation of the present invention, wherein:

FIG. 1 is a flowchart of the first embodiment according to the invention; and

FIG. 2 is a flowchart of the second embodiment according to the invention.

### DETAILED DESCRIPTION OF THE INVENTION

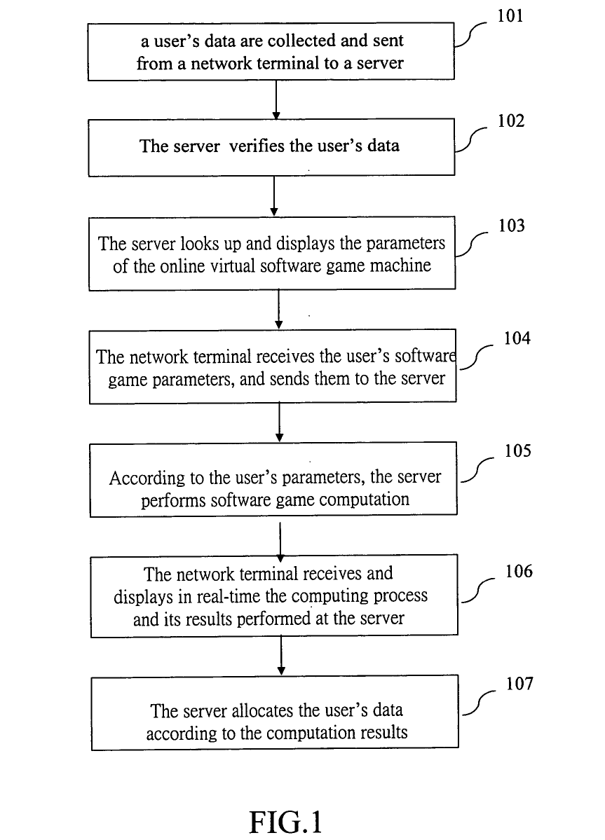

FIG. 1 is a flowchart illustrating a method of conducting a network software game according to an embodiment of the invention. Initially, a user's data are collected and sent from a network terminal to a server (step 101). The user's data can include information such as a user's name, password, account number, etc. The server then verifies the user's data (step 102). The server looks up and displays the parameters of the online virtual software game machine (step 103). The number of virtual software game machines can be one or more than one. The network terminal then receives the user's software game parameters, and sends them to the server (step 104). The parameter data can include stake history data, previous total counters, winner drawing history data, etc. According to the user's parameters, the server performs software game computation (105). The user's parameters can include the software game machine selected by the user, the amount at stake, etc. The network terminal receives and displays in real-time the computing process and its results performed at the server (106). The server allocates the user's data according to the computation results (107).

While the server is conducting the game computing process, the network terminal can monitor in real-time the operational mode of the software game machine selected by the server. The user thereby can observe the game progress.

If the final results obtained by the server indicate that a user has won, the server will update the counter data of the user's account according to the user's stake and the rules of the game, and accordingly increases the counter figure. Meanwhile, the stake history and the drawing history of the selected software game machine are both updated.

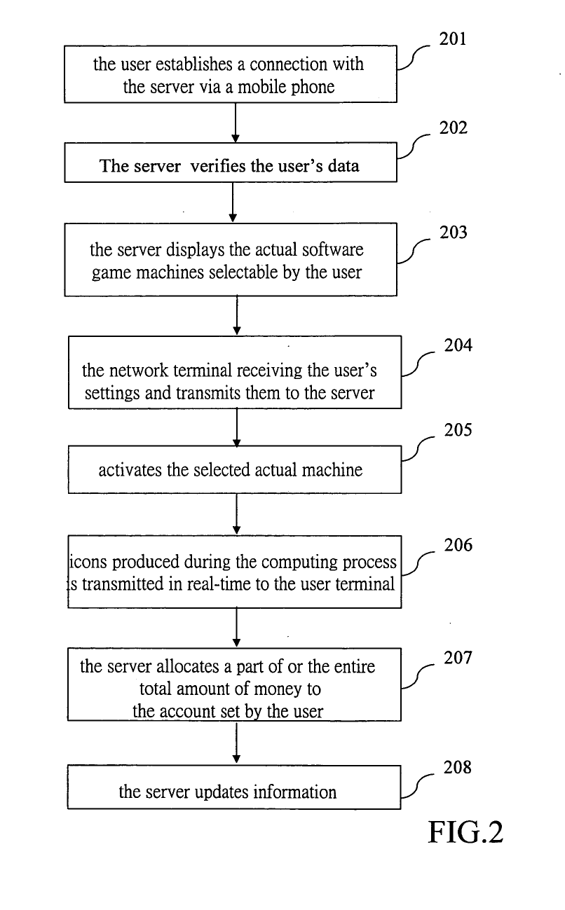

Referring to FIG. 2, the user can establish a connection with the server via a mobile phone (step 201). Communication with the server can be conducted via short message services or wireless connection. The server then verifies the user's data (step 202). If the user is not registered, the user is invited to register and provide user's information such as the capital account number. If the user is already registered, the corresponding user's data are displayed for confirmation. Subsequently, the server displays the actual software game machines selectable by the user (step 203). For example, if actual software game machine number 1, 2 and 3 are currently available for use, the current status of each machine is shown to the user for selection, and the machine's current status includes information such as its total amount of money, a daily stake status, a daily drawing history, etc. According to the current status, the user selects one software game machine, for example the machine number 1. According to the game rules of the selected machine, the user then sets the software game data, and the network terminal, after receiving the-user's settings, and transmits them to the server (step 204). According to the actual machine selected by the user, the server establishes communication between the selected machine and the user, and subsequently activates the selected actual machine according to the software game settings such as, for example, a stake sum (step 205). The selected machine then performs random computing, wherein icons produced during the computing process can be transmitted in real-time to the user terminal as well as the result of the computation process (step 206). If the result of the computation process indicates that the current user's stake wins, the server allocates the capital of the user's account according to the sum of the stake and the game rules of the selected game machine: the server thereby can allocate a part of or the entire total amount of money to the account set by the user (step 207). After the user's stake at the selected software game machine has been received, the server updates the transaction record of the game machine according to the results of the current computation process: in other words, the server updates information such as the current total amount of money and the drawing status (step 208).

Before the selected software game machine performs the game computation process, the server verifies whether the user's counter is sufficient for the current software game session. The server can also set different game rules with respect to different software game machines, such as the maximal stake.

It will be apparent to the person skilled in the art that the invention as described above may be varied in many ways, and notwithstanding remaining within the spirit and scope of the invention as defined in the following claims.

What are claimed:

1. A method of conducting a network virtual software game, implemented to play a software game on a virtual software game machine via a network connection, which includes:
a network terminal collects user's data and transfers data to a server;
the server verifies the user's data;
the server looks up and displays parameter data of the online software game machine;
the network terminal receives and transfers the software game parameter data set by the user to the server;
according to the software game parameter data set by the user, the server conducts a game computation process;
the network terminal receives and displays in real-time the game computation process and its results thereof; and
according to the results of the game computation process, the server allocates the user's data.

2. The method of claim 1, wherein the user's data include a user name, password, and account data.

3. The method of claim 1, wherein the online software game machine includes a plurality of software game machines.

4. The method of claim 1, further comprising that the network terminal receives and transfers data of a software game machine selected by the user to the server, after the server displays parameter data of the online software game machine.

5. The method of claim 1, wherein the parameter data of the online software game machine include a game stake history, a current total counter, and a game drawing history.

6. The method of claim 1, wherein the software game parameter data set by the user include a game stake.

7. The method of claim 1, wherein according to the software game parameter data set by the user, the server conducts a game computation process which comprises driving a computation process of the virtual software game machine according to the selected software game machine and the game stake.

8. The method of claim 1, wherein the network terminal receives and displays in real-time the game computation process and results thereof further comprises the network terminal monitoring in real-time a process status of the selected virtual software game machine at the server end.

9. The method of claim 1, wherein according to the results of the game computation process the server allocates the user's data further comprises allocating counter data of a user's account according to a winner drawing status.

10. The method of claim 1, wherein according to the results of the game computation process the server allocates the user's data further comprises the server updating the parameter data of the software game machine according to the status of the game computation process of the machine.
